(19) United States
(12) Patent Application Publication
(10) Pub. No.: US 2019/0295098 A1
(43) Pub. Date: Sep. 26, 2019

(54) Performing Real-Time Analytics for Customer Care Interactions

(71) Applicant: International Business Machines Corporation, Armonk, NY (US)

(72) Inventors: Indervir Singh Banipal, Austin, TX (US); James D. Wiggins, Austin, TX (US); Shikhar Kwatra, Morrisville, NC (US); Maharaj Mukherjee, Poughkeepsie, NY (US)

(73) Assignee: International Business Machines Corporation, Armonk, NY (US)

(21) Appl. No.: 15/927,319

(22) Filed: Mar. 21, 2018

(51) Int. Cl. G06Q 30/00; G06F 17/27; G06F 15/18

(52) U.S. Cl. CPC G06Q 30/016; G06F 15/18; G06F 17/2785

(57) ABSTRACT

A system, computer program product, and method are provided to analyze an interaction associated with a dialogue. An intelligent real-time analytics using natural language processing (NLP) monitors and analyzes customer dialogue. The system performs analytics on a detected or received dialogue to mine data associated with attributes unique to one or more human communication patterns. The NLP-based system generates and measures a tone, and classifies the tone into a category.

### BACKGROUND

The present embodiment(s) relate to natural language processing. More specifically, the embodiment(s) relate to an artificial intelligence platform to perform real-time analytics on customer care interactions though use of a natural language processing (NLP) algorithm.

In the field of artificial intelligent computer systems, natural language systems (such as the IBM Watson™ artificial intelligent computer system and other natural language question answering systems) process natural language based on knowledge acquired by the system. Machine learning, which is a subset of Artificial intelligence (AI), utilizes algorithms to learn from data and create foresights based on this data. AI refers to the intelligence when machines, based on information, are able to make decisions, which maximizes the chance of success in a given topic. More specifically, AI is able to learn from a data set to solve problems and provide relevant recommendations. AI is a subset of cognitive computing, which refers to systems that learn at scale, reason with purpose, and naturally interact with humans. Cognitive computing is a mixture of computer science and cognitive science. Cognitive computing utilizes self-teaching algorithms that use data minimum, visual recognition, and natural language processing to solve problems and optimize human processes.

The tone of customer communications, e.g., customer feedback (positive and negative) and customer complaints is an important facet of the overall customer interaction experience. Valuable insight into customer attitudes towards an entity and its products and services may be ascertained from the tone of the customer feedback. Automated customer service systems are not configured to perform further analytics on text being read to mine data associated with attributes of text unique to human communication patterns, e.g., the tone, i.e., the overall attitude, demeanor, or sentiment of the text as generated by the customer.

### SUMMARY

The embodiments include a system, computer program product, and method for natural language processing directed at performing real-time analytics on interactions.

In one aspect, a system is provided with a processing unit operatively coupled to memory, with an artificial intelligence platform in communication with the processing unit. The AI platform includes a tone manager in communication with the processing unit, with the tone manager is configured to read an interaction record and generate a tone graph based on the interaction record. The AI platform also includes an analyzer in communication with the tone manager. The analyzer is configured to identify and analyze one or more characteristics within the generated tone graph. The AI platform further includes a classifier in communication with the analyzer, with the classifier configured to classify a state of the analyzed interaction record based on the analysis of the one or more characteristics identified by the analyzer within the generated tone graph. The system further includes a hardware device operatively coupled to the classifier and the processing unit. The hardware device is configured to receive an instruction output associated with the classified state of the analyzed interaction record. Receipt of the instruction causes a physical action related to the hardware device. The physical action is in the form of a state change of the hardware device, actuation of the hardware device, and/or maintaining an operating state of the hardware device.

In another aspect a computer program product is provided to process natural language. The computer program product includes a computer readable storage device having embodied program code that is executable by a processing unit. Program code is provided to read an interaction record and generate a tone graph based on the interaction record. Program code is also provided to identify and analyze one or more characteristics within the generated tone graph. Program code is further provided to classify a state of the analyzed interaction record based on the analysis of the one or more characteristics identified by the analyzer within the generated tone graph. Program code is also provided to transmit an instruction output associated with the classified state of the analyzed interaction record to a hardware device. The instruction output is further received by the hardware device, wherein the instruction output is associated with the classified state of the analyzed interaction record. Program code is provided to perform a physical action in relation to the hardware device, with the physical action being in the form of a state change of the hardware device, actuation of the hardware device, and/or maintaining an operating state of the hardware device.

In yet another aspect, a method is provided for processing natural language. The method includes reading an interaction record and generating a tone graph based on the interaction record. One or more characteristics within the generated tone graph are identified and analyzed. In addition, a state of the analyzed interaction record is classified based on the analysis of the one or more characteristics identified within the generated tone graph. The method also includes transmitting an instruction output associated with the classified state of the analyzed interaction record to a hardware device. Receipt of the instruction output by the hardware device includes performing a physical action in the form of a state change of the hardware device, actuation of the hardware device, and/or maintaining an operating state of the hardware device.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings reference herein forms a part of the specification. Features shown in the drawings are meant as illustrative of only some embodiments, and not of all embodiments, unless otherwise explicitly indicated.

FIG. 1 depicts a schematic system diagram illustrating a natural language processing system for analyzing an interaction.

FIG. 2 depicts a graphical illustration of a sample tone graph with a satisfactory rating.

FIG. 3 depicts a graphical illustration of a sample tone graph with an unsatisfactory rating.

FIG. 4 depicts a graphical illustration of a sample tone graph with a neutral/partially satisfactory rating.

FIG. 5 depicts a flow chart demonstrating the functionality of the system for analyzing an interaction.

FIG. 6 depicts a flow chart demonstrating the functionality of the system for training the system to classify a tone graph.

FIG. 7 depicts a flow chart demonstrating the functionality of the system for leveraging the analysis of an interaction.

### DETAILED DESCRIPTION

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiments. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

An intelligent system is provided with tools and algorithms to run intelligent real-time analytics using natural language processing (NLP) to monitor and analyze dialogue, e.g., speech and its attributes. In one embodiment, the dialogue may pertain to an interaction between a customer and a customer service representative (CSR). More specifically, the system receives the dialogue and performs analytics on the associated dialogue data, and in one embodiment a text of the dialogue data, to mine data associated with attributes of the dialogue that align with a communication pattern. An example of such attributes includes, but is not limited to, the tone, i.e., the overall attitude, demeanor, or sentiment of the dialogue. In one embodiment, the dialogue may be analyzed in audio format, or a combination of audio and video format. The tone of communications present in the dialogue, e.g., positive feedback and negative feedback, is an important facet of the dialogue and provides valuable insight into attitude(s) towards an entity and its products and services. The NLP-based system measures the tone in terms of excitement, frustration, impoliteness, politeness, sadness, satisfaction, and sympathy. The generated tone can be defined in a category, such as satisfactory, un-satisfactory, or neutral/partially satisfactory. The disclosed intelligent system has the capability to escalate an interaction if the measured tone is determined to not be at a satisfactory level, hence preventing an immediate low rating. In addition, the system includes features such as detecting anomalous feedback, e.g., those interactions or ratings that are significantly incongruous with the determined tone rating. Moreover, the system can discriminate between interactions that have an expected low satisfaction outcome from those interactions where no such expectation exists. Accordingly, the tools and algorithms are described in detail below use the tone of the interaction as input, with analysis thereof conducted by natural language processing (NLP) and machine learning (ML).

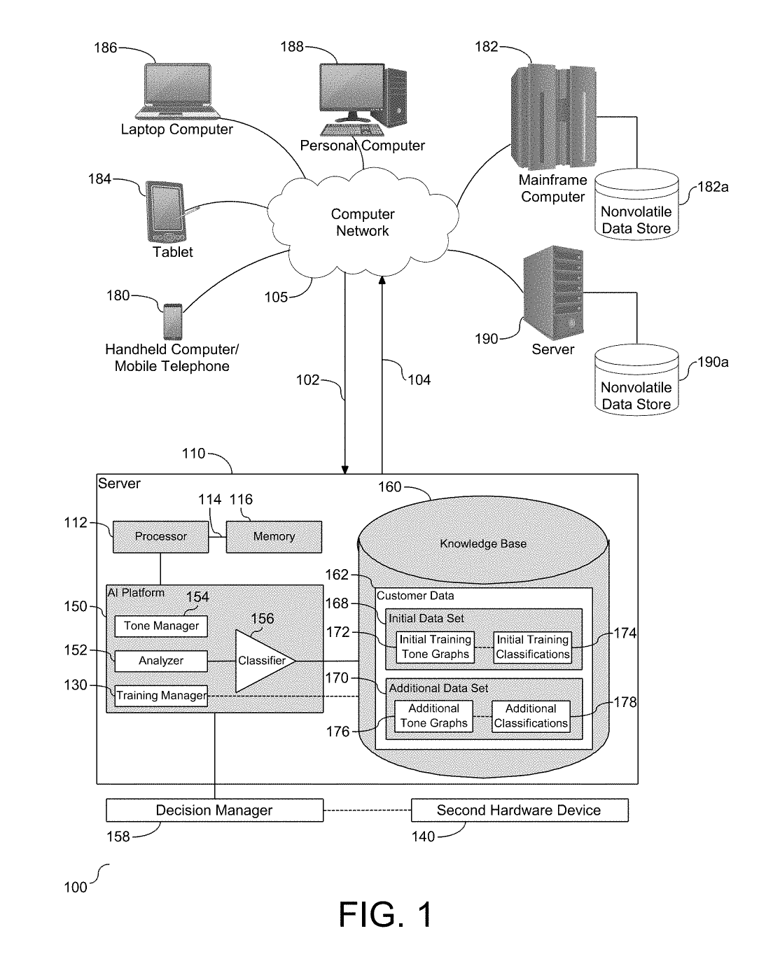

Referring to FIG. 1, a schematic diagram of a natural language processing system (100), i.e., a system for analyzing an interaction is depicted. As shown, a server (110) is provided in communication with a plurality of computing devices (180), (182), (184), (186), (188), and (190) across a network connection (105). The computer network may include several devices. Types of information handling systems that can utilize system (110) range from small handheld devices, such as a handheld computer/mobile telephone (180) to large mainframe systems, such as a mainframe computer (182). Examples of a handheld computer (180) include personal digital assistants (PDAs), personal entertainment devices, such as MP4 players, portable televisions, and compact disc players. Other examples of information handling systems include pen or tablet computer (184), laptop or notebook computer (186), personal computer system (188) and server (190). As shown, the various information handling systems can be networked together using computer network (105).

The computing devices (180), (182), (184), (186), (188), and (190) communicate with each other and with other devices or components via one or more wires and/or wireless data communication links, where each communication link may comprise one or more of wires, routers, switches, transmitters, receivers, or the like. In this networked arrangement, the server (110) and the network connection (105) may enable natural language processing and interaction analysis for one or more content users. Other embodiments of the server (110) may be used with components, systems, sub-systems, and/or devices other than those that are depicted herein.

Various types of a computer network (105) can be used to interconnect the various information handling systems, including Local Area Networks (LANs), Wireless Local Area Networks (WLANs), the Internet, the Public Switched Telephone Network (PSTN), other wireless networks, and any other network topology that can be used to interconnect information handling systems and computing devices. Many of the information handling systems include non-volatile data stores, such as hard drives and/or non-volatile memory. Some of the information handling systems may use separate non-volatile data stores (e.g., server (190) utilizes non-volatile data store (190a), and mainframe computer (182) utilizes non-volatile data store (182a)). The non-volatile data store (182a) can be a component that is external to the various information handling systems or can be internal to one of the information handling systems.

The server (110) is configured with a processing unit (112) operatively coupled to memory (116) across a bus (114). An artificial intelligence (AI) platform (150) is shown embedded in the server (110) and in communication with the processing unit (112). In one embodiment, the AI platform (150) may be local to memory (116). The AI platform (150) provides support for running intelligent real-time analytics using natural language processing (NLP) to monitor and analyze dialogue data during an interaction between two parties in real-time, such as a customer and a customer service representative (CSR). As shown, the AI platform (150) includes tools which may be, but are not limited to, an analyzer (152), a tone manager (154), a classifier (156), and a training manager (130). Each of these tools functions separately or combined in the AI platform (150) to dynamically analyze the tone of the dialogue and determine and/or initiate a course of action based on the analysis. As shown, the AI platform (150) provides dialogue interaction analysis over the network (105) from one or more computing devices (180), (182), (184), (186), (188), and (190).

As further shown, a knowledge base (160) is provided local to the server (110), and operatively coupled to the processing unit (112) and/or memory (116). In one embodiment, the knowledge base (160) may be in the form of a database. The knowledge base (160) includes a library (162), also referred to herein as a tone graph and classification library, with several components. The library (162) includes an initial data set (168) and an additional data set (170). The initial data set (168) is shown to include initial training tone graphs (172) and initial training classifications (174). The additional data set (170) is shown to include additional tone graphs (176) and additional classifications (178). The initial data set (168) is used to execute an initial training of the AI platform (150) with existing tone graphs and their associated classifications. The additional data set (170) is shown to include tone graphs and their associated classifications that are generated subsequent to the initial training of the AI platform (150), which in one embodiment, may be created in real-time, e.g., during the dialogue. In one embodiment, the additional data set (170) may be used for subsequent training and refining of the AI platform (150), record storage for documentation purposes, or for increasing the volume of training records for the initial data set (168). As shown, the knowledge base (160) provides access to the library (162) over the network (105) from one or more computing devices (180), (182), (184), (186), (188), and (190).

The various computing devices (180), (182), (184), (186), (188), and (190) in communication with the network (105) demonstrate access points to the AI platform (150) and the associated knowledge base (160). Some of the computing devices (180), (182), (184), (186), (188), and (190) may include devices for a database storing at least a portion of the library (162) stored in knowledge base (160). The network (105) may include local network connections and remote connections in various embodiments, such that the knowledge base (160) and the AI platform (150) may operate in environments of any size, including local and global, e.g., the Internet. Additionally, the server (110) and the knowledge base (160) serve as a front-end system that can make available a variety of knowledge extracted from or represented in documents, network accessible sources, and/or structured data sources.

The server (110) may be the IBM Watson™ system available from International Business Machines Corporation of Armonk, N.Y., which is augmented with the mechanisms of the illustrative embodiments described hereafter. The IBM Watson™ knowledge manager system imports knowledge into natural language processing (NLP). Specifically, as described in detail below, as dialogue data is received, organized, and/or stored, the data will be analyzed to determine the tone of the underlying data within the dialogue and assign an appropriate rating to the dialogue, e.g., interaction. The server (110) alone cannot analyze the data and determine an appropriate rating for the interaction due to the nuances of human conversation, e.g., inflections, volume, use of certain terms, including slang, and the like. As shown herein, the server (110) receives input content (102), e.g., audio, video, and/or text translation of the dialogue, which it then evaluates to determine the tone of the dialogue as a function of time throughout the interaction and then assign a rating to the interaction based on tone trends. In particular, received content (102) may be processed by the IBM Watson™ server (110) which performs analysis to evaluate the tone of the dialogue from the input content (102) using one or more reasoning algorithms.

The natural language processing system (100) includes a tone manager (154) in communication with the processing unit (112) to read an interaction record. The analyzer (152) is in communication with the tone manager (154). In one embodiment, the tone manager (154) regulates operation of the analyzer (152) and the classifier (156). The interaction record is typically a record generated substantially simultaneously in real-time during the associated interaction through a voice recognition/dictation application. In one embodiment, the interaction record is in text format. The analyzer (152) identifies and analyzes one or more characteristics within the interaction record received from the tone manager (154) and generates a graph, also referred to herein as a tone graph, based on the interaction record.

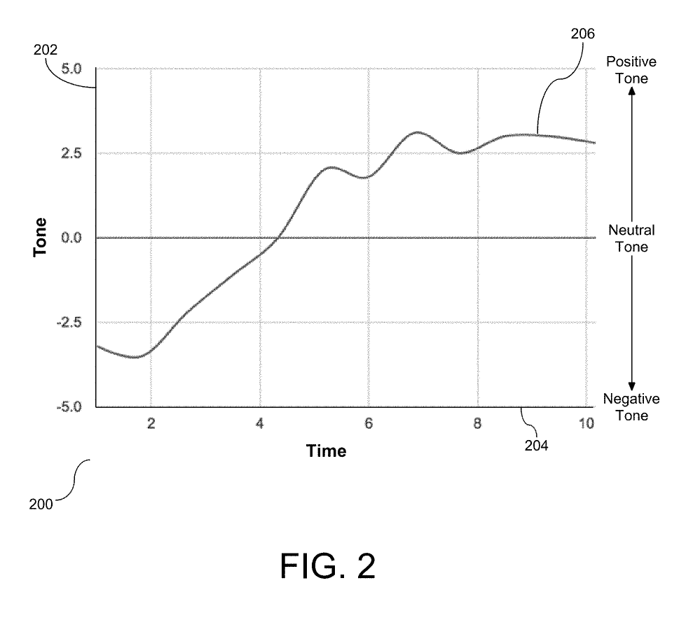

An example of a tone graph is shown and described in FIG. 2. Specifically, FIG. 2 depicts a graphical illustration of a sample tone graph (200) with a satisfactory rating. As shown, the graph (200) includes an ordinate (y-axis) (202) that extends from a unit less value of −5.0 to +5.0 in 2.5 unit increments. The value 0.0 is indicative of a neutral tone, a positive value is indicative of a positive tone, and a negative value is indicative of a negative tone. The larger the value of the number associated with the tone, the greater the determined positive attitude toward the present interaction. Greater negative values are indicative of a greater negative attitude associated with the interaction. The graph (200) also includes an abscissa (x-axis) (204) that extends from approximately a unit less value of 1 to approximately a unit less value of 10 in increments of 2 units.

The analyzer (152) receives the interaction record, which in one embodiment is in the form of a text transcription of the interaction in real-time, and analyzes interaction record. The analyzer (152) generates output data, which in one embodiment may include up to seven dimensions. Examples of the dimensions may include, but are not limited to, i.e., excitement, frustration, impoliteness, politeness, sadness, satisfaction, and sympathy. In one embodiment, one or more of the dimensions may be scaled based on known relationships between various aspects of dialogue data, e.g., speech characteristics, such as speech inflection(s), slang, exclamation(s), and the like. Once the analysis is completed, the results are rescaled from two or more dimensions to a single dimension representing tone on a linear scale ranging from −x to +x based on whether the underlying dialogue data is determined to exhibit a negative tone, such as angry or sad, a positive tone, such as happiness, excitement, or a neutral tone. In one embodiment, the dimensionality reduction is performed by one or more available techniques, e.g., Principle Component Analysis (PCA). Once the dimensional reduction is complete, either the tone manager (154) or the analyzer (152) generates the tone graph (similar to tone graph 200) for each interaction, e.g., dialogue, by plotting the tone in a scaled range (−x to +x) against the start time and end time of the associated interaction.

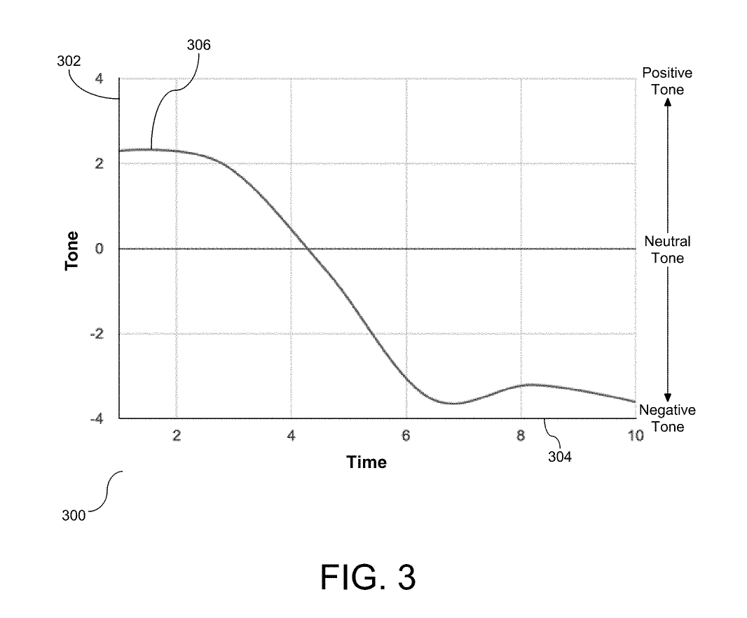

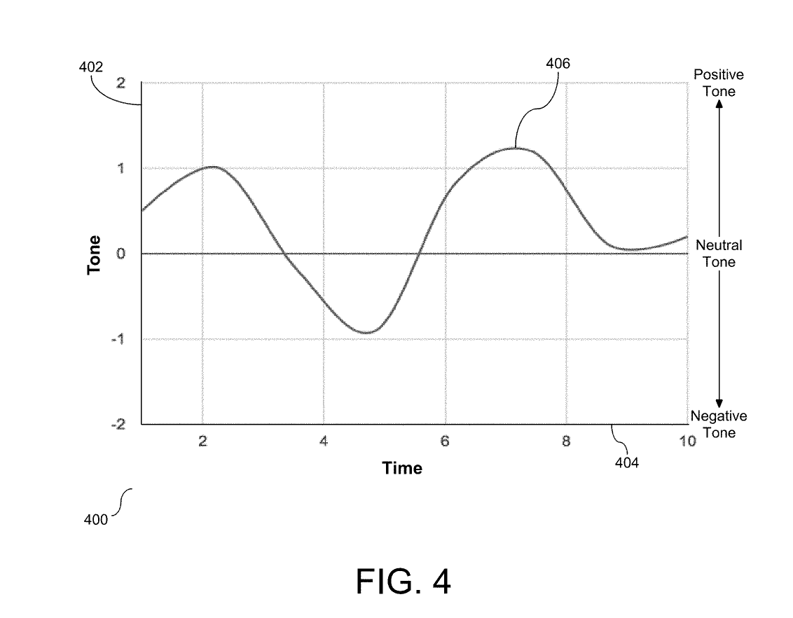

The natural language processing system (100) is further shown to include the classifier (156) in communication with the analyzer (152). The classifier (156) functions to receive the tone graph from the analyzer (152) and classify a state of the analyzed interaction record based on the analysis of the one or more characteristics identified by the analyzer (152) within the generated tone graph. In one embodiment, each generated tone graph is assigned a classification, also referred to herein as a classified state. Examples of the classified state includes at least one classification, including “satisfactory” (designated with a “Y” rating) as shown in tone graph (200), “un-satisfactory” (designed with an “N” rating) as shown in tone graph (300) described in detail in FIG. 3, or “neutral/partially satisfactory” (designated with an “Neutral” rating) as shown in tone graph (400) described in detail in FIG. 4.

As shown in FIG. 2, a trace (206) is shown representing the tone of the dialogue as a function of time. In one embodiment, the trace (206) is produced from a curve fit applied to a graph of the tone data. In the example provided, the time at the outset of the dialogue starts out negative, passes through the neutral line slightly after time equals 4, and the interaction ends with a positive tone. The tone graph (200) is rated as satisfactory based on the characteristics of the trace (206) and is assigned a “Y” designation. Accordingly, the trace (206) functions as representing a characteristic of the trend represented by the data that populates the graph, which is shown in this example graph (200) to have a positive designation.

Referring to FIG. 3, a graphical illustration of a sample tone graph (300) with an unsatisfactory rating is provided. Graph (300) is similar to graph (200) with a different data set representation. As shown, tone graph (300) includes an ordinate (y-axis) (302) that extends for a unit less value of −4.0 to +4.0 in 2.0 unit increments. The graph (300) also includes an abscissa (x-axis) (304) that extends from approximately a unit less value of 1 to approximately a unit less value of 10 in increments of 2 units. A trace (306) is depicted in the tone graph, with the trace representing the tone of the dialogue as a function of time during the interaction. Similar to trace (206), trace (306) may be produced from a curve fit applied to a graph of the tone data. The trace (306) is shown herein to start with a positive value, and continues during the passage of time to pass through the neutral line slightly after time equals 4. The interaction is shown to conclude with a negative tone. The tone graph represented is designated as unsatisfactory based on the characteristics of the trace (306) and is assigned an “N” designation. Accordingly, the trace (306) functions as representing a characteristic of the trend represented by the data that populates the graph (300), which is shown in this example to have a negative designation.

Referring to FIG. 4, a graphical illustration of a sample tone graph (400) with a neutral rating is provided. As shown, tone graph (400) includes an ordinate (y-axis) (402) that extends from a unit less value of −2.0 to +2.0 in 1.0 unit increments. The graph (400) also includes an abscissa (x-axis) (404) that extends from approximately a unit less value of 1 to approximately a unit less value of 10 in increments of 2 units. A trace (406) is depicted in the tone graph, with the trace representing the tone of the dialogue as a function of time during the interaction. Similar to trace (206), trace (406) may be produced from a curve fit applied to a graph of the tone data. The trace (406) is shown herein to start with a positive value, and continues during the passage of time to pass through the neutral line slightly after time equals 3. The interaction is shown to trends negative and then reverses, turn positive while passing through the neutral line between times 5 and 6, and the interaction ends with a slightly positive tone. The tone graph represented is designed as neutral based on the characteristics of the trace (406) and is assigned a “Neutral” designation. Accordingly, the trace (406) functions as representing a characteristic of the trend represented by the data that populates the graph, which is shown in this example graph (400) to have a neutral designation.

The three designations of Y, N, and Neutral shown and described in FIGS. 2-4, respectively, should be recognized as an example of one ratings system of a near infinite number of ratings systems and, therefore, should be viewed as non-limiting. Any ratings system employing one or more algorithms for determining a rating or other designation may be utilized to analyze and classify dialogue data.

As shown and described, system (100) analyzes and classifies dialogues and associated interactions in real-time. The classifier (156) determines a tone trend in real-time and generates a predicted outcome of the interaction record based on the tone trend. That is, the system (100) analyzes the current on-going tone graph on a real-time basis and predicts a level of satisfaction before the interaction concludes. In addition, the system (100) analyzes the tone of the interaction and classifies the interaction record to compare any post-interaction ratings (typically gathered during a post-interaction survey) against an expected negative classified tone graph. Accordingly, the system (100) functions to analyze the dialogue in real-time, as well as analyze post dialogue interaction and feedback data.

For example, the dialogue may be an interaction with a customer service representative (CSR) and a prospective customer, with the customer being a smoker and the CSR being a health insurance entity. The customer inquires with the CSR about health insurance eligibility. An example response may include that either the customer is not eligible to obtain health insurance, or can obtain the insurance at an expensive premium. Either of these two responses may be expected to generate a negative tone from the customer with respect to the dialogue. Furthermore, in situations where, for example, the CSR is asked a question by the customer, the CSR reviews a company policy, and politely responds to the customer based on the reviewed policy. Based on this example, it is likely that the customer will likely generate a negative rating for the interaction record. The NLP system (100) determines if the CSR was acting strictly in accordance with company policy or frequently asked questions (FAQs) through methods that may include an intelligent comparison of the dialogue interaction record against the company policy and FAQs. If the CSR is determined to act strictly according to policy, the interaction is flagged for such determination. If the CSR is determined to not act strictly according to policy, the interaction is flagged for further review. Accordingly, the system (100) functions to analyze the data to determine if an interaction with a customer resulting in a negative classification was expected or was a result of an error on the part of the CSR.

The NLP system (100) is shown to further include a decision manager (158). In one embodiment, the decision manager (158) is a hardware device operatively coupled to the server (110) and in communication with the AI platform (150) and the associated tools. The decision manager (158) is also operably coupled to the processing unit (112) and receives an instruction output from the processing unit (112) associated with the classified state, e.g. positive, negative, or neutral, of the analyzed interaction record. The receipt of the instruction from the processing unit (112) causes a physical action associated with the decision manager (158). Examples of the physical action include, but are not limited to, a state change of the decision manager (158), actuation of the decision manager (158), and maintaining an operating state of the decision manager (158).

The decision manager (158) facilitates managing anomalous interaction records, e.g., those records that have at least one unusual characteristic as described further below. Upon the determination by the classifier (156) that a particular interaction record is anomalous, a processing instruction is transmitted from the processing unit (112) to the decision manager (158), which undergoes a change of state upon receipt of the associated instruction. In one embodiment, the classifier generates a flag or instructs the processing unit (112) to generate the flag, with the flag directly corresponding to a state of the decision manager (158). More specifically, the decision manager (158) may change operating states in response to receipt of the flag and based upon the characteristics or settings reflected in the flag. The change of state includes the decision manager (158) changing states, such as shifting from a first state to a second state. In one embodiment, the first state is a reviewing state, also referred to herein as an inactive state, and the second state is a labeling state, also referred to herein as an active state. In the second state, the classifier (156) makes a determination with respect to labeling of the associated interaction record. If a particular interaction record is determined to be anomalous by the classifier (156), the decision manager (158) is flagged to assign a label to the interaction record that will be one of “biased” or “non-genuine”. More specifically, the classifier (156) can detect biased ratings using accessible information as to whether the rating (typically recorded as part of a survey post-interaction) and tone graph(s) have incongruent assigned ratings. For example, under the circumstances when the dialogue is assigned a rating of one star out of five stars for satisfaction on the post-interaction survey, the classifier (156), or in one embodiment, the processing unit (112), will flag the survey. The classifier (156) reviews the associated tone graph, and if the tone graph received a positive rating the associated interaction record may qualify for a “biased” rating with the bias being reflected in the post-interaction survey results.

Similarly, the anomalous interaction record may include either a “genuine” label or a “non-genuine” label. An example of a non-genuine label is an interaction record that includes a high post-interaction survey rating of five out of five stars, while the associated tone graph received a rating from the classifier (156) as either Negative or Neutral, i.e., not positive. A genuine interaction label is contrasted to a non-genuine label with the genuine label having little to no ambiguous and/or incongruous data within the record.

While two examples of anomalous interaction records are described above, it will be understood that these two examples are non-limiting and any incongruent comparisons between the tone graph and any other portion of an overall interaction record will cause the decision manager (158) to change states, e.g., change between an inactive state and an active state. The described state change of the decision manager (158) from between the inactive and active states should be viewed as a non-limiting example of a change in state of the hardware-based decision manager (158). Once the decision manager (158) completes assigning the labels to the associated interaction records in the active state, the decision manger (158) will be commanded to return to the reviewing mode in the inactive state. In some embodiments, the decision manager (158) may also have to be actuated to assign the labels to the associated interaction records.

Another example of the decision manager (158) undergoing a change of state upon receipt of the instruction from the processing unit (112) includes the classifier (156) detecting a genuine interaction record read by the tone manager (154), analyzed by the analyzer (152), and classified by the classifier (156). The classifier (156) determines if a particular rating assigned by the classifier (156) was either “expected” or “unexpected”. The categories of expected and unexpected are at least partially based on a particular characteristic of the interaction record assessed by the classifier (156), such assessed characteristics likely to elicit a particular customer tone in reaction to that characteristic. The classifier (156) also determines a source of the interaction record corresponding to the assessed characteristic, e.g., a portion of the text of the customer interaction.

For example, reconsidering the example of a customer inquiring with a health insurance entity about how smoking may affect the coverage, the decision manager (158) will experience a change of state from inactive to active to categorize the resultant tone graph as either expected or unexpected. Specifically, providing a customer with information contrary to their perceived best interests will understandably result in a negative tone reflecting the customer's dissatisfaction with the information. Therefore, a negative tone graph would be expected. However, if a customer feedback yields a positive or neutral tone graph after receiving such information, the tone graph will be categorized as unexpected. The categorizations of expected and unexpected can also be applied to the examples provided above. Further, the described categorizations of the classifier (156) including expected and unexpected should be viewed as a non-limiting example of categorizations assigned by the decision manager (158) based on direction from the classifier (156). Specifically, the classifier (156) includes one or more algorithms to assign any number and type of categorizations to categorize the interaction record per the desires of the practicing entity to enable operation of system (100) as described herein. Once the assigned tasks are completed, the decision manger (158) will be commanded to return to the previous mode. In some embodiments, the decision manager (158) may also have to be actuated to perform the assigned tasks. Accordingly, the decision manager (158) functions to assign the appropriate labels to the interaction records and to experience a state change or actuation based upon the label assignment.

An example of the decision manager (158) being actuated may include one or more of the examples above, as well as the decision manager (158) actuating a second hardware device (140) in response to a tone graph trending toward an unsatisfactory, e.g. negative, classification in real-time during an interaction. In one embodiment, the second hardware device (140) is a physical telephone assigned to an individual with a responsibility of receiving escalation of a customer interaction, such as a manager of a CSR. For example, if the real-time measured tone within a tone graph remains below the neutral line in the negative tone region for an extended period of time, the decision manager (158) will undergo a change of state from a reviewing mode to an escalation mode, and then actuate the escalation of the call by transferring the call from the CSR to the manager who will be directed to continue the interaction through the second hardware device (140), which is now shifted from a first state, i.e., an inactive mode, to a second state, i.e., an active mode. The described example actuation of the decision manager (158) and the second hardware device (140) should be viewed as a non-limiting example of such actuations. Once the escalated interaction is completed, the decision manger (158) and the second hardware device (140) will be commanded to return to the prior states represented herein as the review mode and the inactive mode, respectively.

Under some circumstances, the operating state of the decision manger (158) will be maintained. For example, the sequence of classified dialogue records may be such that each tone graph in the sequence requires some action from the decision manager (158). Also, under other circumstances, the sequence of tone graphs classified by the classifier (156) will not require any action and the decision manager (158), which is in a reviewing state, will remain in the reviewing state.

The AI platform (150) also includes a training manager (130) shown herein operatively coupled to the knowledge base (160). The training manager (130) may be either a hardware device or a software module that receives an instruction output from the processing unit (112) associated with management of the training resources, e.g., the initial data set (168), within the knowledge base (160). The training manager (130) includes one or more algorithms to leverage the knowledge base (160) to store and manage the initial data set (168). As shown in the exemplary system shown in FIG. 1, the library (162) includes customer data for the practicing entity. In some embodiments, the customer data is spread across multiple devices and/or sites in a distributed data configuration. The library (162) includes a plurality of data records that are distributed between an initial set of training tone graphs (172) and initial training classifications (174) portions of the initial data set (168). The initial training tone graphs (172) include tone graphs that have been evaluated and determined to be suitable for training the classifier (156). The initial training classifications (174) are the positive, negative, and neutral ratings associated with the initial training tone graphs (172). The training manager (130) regulates the training of the classifier (156) through use of the initial data set (168) to execute the initial training of the classifier (156) with the resident tone graphs and their associated classifications such that a sense of confidence is attained with respect to the classifier (156) being sufficiently trained to classify new tone graphs.

The training manager (130) also manages one or more additional tone graphs (176) and additional classifications (178) of the additional data set (170). The additional data set (170) includes tone graphs and their associated classifications that are generated during live interactions subsequent to the initial training of the classifier (156). The additional data set (170) may be used for subsequent training and refining of the classifier (156) through the training manager (130). In some embodiments, the processing unit (112) or the decision manger (158) will send an instruction to the training manager (130) to conduct a “training session” with the classifier (156). Accordingly, the classifier (156) may be placed into live service once the initial training activities as described above are completed.

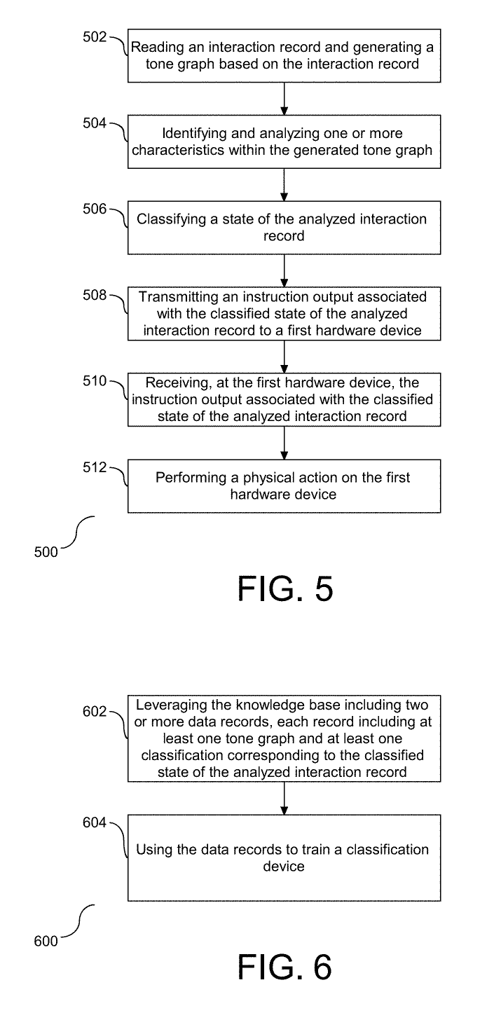

With reference to FIG. 5, a flow chart (500) is provided illustrating a process for analyzing an interaction. The process, or method, for analyzing the interaction includes reading an interaction record and generating a tone graph based on the interaction record (502). As shown and described in FIG. 1, the interaction record is read by the tone manager (154) and the tone graph is generated by the analyzer (152). The process also includes identifying and analyzing one or more characteristics within the generated tone graph (504). The process further includes classifying a state of the analyzed interaction record (506) through the classifier (156) based on analysis of the one or more characteristics identified by the analyzer (154) within the generated tone graph. The classified state of the analyzed interaction record will include a classification that includes one of satisfactory, unsatisfactory, and partially satisfactory. An instruction output associated with the classified state of the analyzed interaction record is transmitted (508) to a first hardware device, i.e., the decision manager (158). The instruction output associated with the classified state of the analyzed interaction record is received (510) at the first hardware device (158). The process also includes performing a physical action selected in the form of changing a state of the decision manager (158), actuating the decision manager (158), and maintaining an operating state of the decision manger (158). Accordingly, as shown, the process for analyzing the interaction results in a classification of the associated interaction record.

As shown in FIG. 5, the interaction analysis includes analysis of the tone graph. With reference to FIG. 6, a flow chart (600) is provided illustrating a process for training the system to classify tone graphs. The process, or method, for training the system (100) to classify tone graphs includes leveraging the knowledge base (160) including two or more data records, each record including at least one tone graph and at least one classification corresponding to the classified state of the analyzed interaction record (602). The tone graphs from the initial data set (168) and the related classification for each tone graph is transmitted to the classifier (156) and employed such that the classifier (156) learns how the traces associated with the graphs define the assigned classification. The training manager (130) manages the training of the classifier through controlling transmission of the data in the initial data set (168) to the classifier (156). Accordingly, the classifier (156) may be placed into live service once the initial training activities as described above are completed.

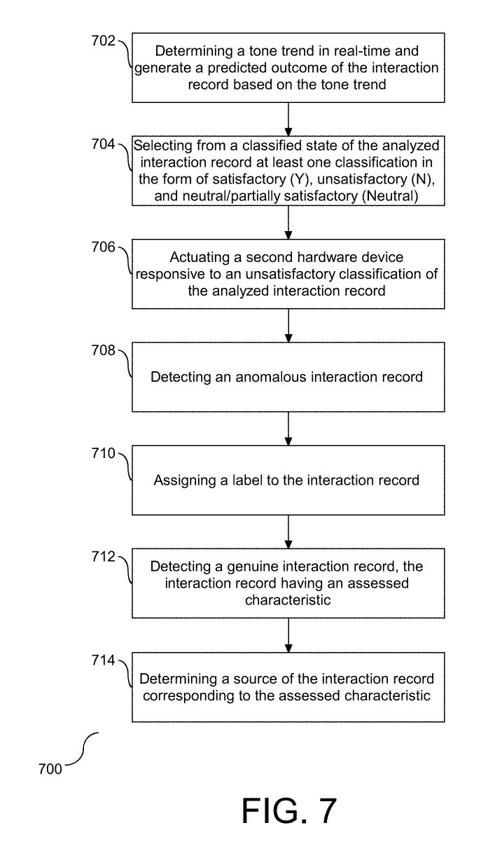

With reference to FIG. 7, a flow chart (700) is provided illustrating a process leveraging the tone analysis process (500). The process, or method, for leveraging the tone analysis process (500) includes determining a tone trend in real-time and generating a predicted outcome of the interaction record based on the tone trend (702). The process also includes selecting from the classified state of the analyzed interaction record at least one classification in the form of satisfactory (Y), unsatisfactory (N), and neutral/partially satisfactory (Neutral) (704). A second hardware device (140) is actuated responsive to an unsatisfactory classification of the analyzed interaction record (706). In one embodiment, the second hardware device (140) is a telephone of an assigned responsible party for escalation of the dialogue and associated interaction. The anomalous interaction record read by the tone manager is detected (708). A label is then assigned to the interaction record (710). The label is in the form of biased and non-genuine. A genuine interaction record is detected (712), the interaction record having an assessed characteristic in the form of expected and unexpected. A source of the interaction record corresponding to the assessed characteristic is determined (714). Accordingly, as shown the system (100) includes functionality to manage interaction records that require more than classification and storage.

The system and flow charts shown herein may also be in the form of a computer program device for use with an intelligent computer platform in order to facilitate NL processing. The device has program code embodied therewith. The program code is executable by a processing unit to support the described functionality.

While particular embodiments have been shown and described, it will be obvious to those skilled in the art that, based upon the teachings herein, changes and modifications may be made without departing from the embodiment and its broader aspects. Therefore, the appended claims are to encompass within their scope all such changes and modifications as are within the true spirit and scope of the embodiment. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles.

The present embodiment(s) may be a system, a method, and/or a computer program product. In addition, selected aspects of the present embodiment(s) may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiment(s) may take the form of computer program product embodied in a computer readable storage medium (or media) having computer readable program instructions thereon for causing a processor to carry out aspects of the present embodiment(s). Thus embodied, the disclosed system, a method, and/or a computer program product are operative to improve the functionality and operation of a machine learning model based on veracity values and leveraging BC technology.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments on may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the present embodiment(s) are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. In particular, the natural language processing may be carried out by different computing platforms or across multiple devices. Furthermore, the data storage and/or corpus may be localized, remote, or spread across multiple systems. Accordingly, the scope of protection of the embodiments is limited only by the following claims and their equivalents.

What is claimed is:

1. A system comprising:
a processing unit operatively coupled to memory;
an artificial intelligence (AI) platform, in communication with the processing unit and the memory, the AI platform comprising:
a tone manager in communication with the processing unit to read an interaction record;
an analyzer in communication with the tone manager, the analyzer configured to identify and analyze one or more characteristics within the generated tone graph and generate a tone graph based on the interaction record; and
a classifier in communication with the analyzer, the classifier to classify a state of the analyzed interaction record based on the analysis of the one or more characteristics identified by the analyzer within the generated tone graph; and
a first hardware device operatively coupled to the classifier and the processing unit, the first hardware device to receive an instruction output associated with the classified state of the analyzed interaction record, wherein receipt of the instruction causes a physical action selected from the group consisting of: a state change of the first hardware device, actuation of the first hardware device, and maintain an operating state of the first hardware device.

2. The system of claim 1, further comprising a training manager operatively coupled to the processing unit, the training manager to leverage a knowledge base coupled to the AI platform, the knowledge base including two or more data records, each record including at least one tone graph and at least one classification corresponding to the classified state of the analyzed interaction record.

3. The system of claim 2, further comprising the classifier to leverage the training manager and the knowledge base to classify a trend of the generated tone graph.

4. The system of claim 1, wherein the classifier is configured to determine a tone trend in real-time and generate a predicted outcome of the interaction record based on the tone trend.

5. The system of claim 4, wherein the classified state of the analyzed interaction record includes at least one classification selected from the group consisting of: satisfactory, unsatisfactory, and partially satisfactory.

6. The system of claim 5, further comprising a decision manager operatively coupled to the classifier, the decision manager to actuate a second hardware device responsive to the unsatisfactory classification of the analyzed interaction record.

7. The system of claim 6, further comprising the classifier to: detect an anomalous interaction record read by the tone manager, and the decision manager to assign a label to the interaction record, the label selected from the group consisting of: biased and non-genuine.

8. The system of claim 6, further comprising the classifier to detect a genuine interaction record read by the tone manager, the interaction record having an assessed characteristic selected from the group consisting of: expected and unexpected, and the classifier to determine a source of the interaction record corresponding to the assessed characteristic.

9. A computer program product to process natural language (NL), the computer program product comprising a computer readable storage device having program code embodied therewith, the program code executable by a processing unit to:
read an interaction record and generate a tone graph based on the interaction record;
identify and analyze one or more characteristics within the generated tone graph;
classify a state of the analyzed interaction record based on the analysis of the one or more characteristics identified by the analyzer within the generated tone graph;
transmit an instruction output associated with the classified state of the analyzed interaction record to a first hardware device; and
receive, at the first hardware device, the instruction output associated with the classified state of the analyzed interaction record; and
the first hardware device to perform a physical action responsive to the received instruction, the physical action selected from the group consisting of: a state change of the first hardware device, actuation of the first hardware device, and maintain an operating state of the first hardware device.

10. The computer program product of claim 9, further comprising program code to:
leverage a knowledge base including two or more data records, each record including at least one tone graph and at least one classification corresponding to the classified state of the analyzed interaction record; and
employ the data records to train a classification device.

11. The computer program product of claim 9, further comprising program code to determine a tone trend in real-time and generate a predicted outcome of the interaction record based on the tone trend.

12. The computer program product of claim 11, further comprising program code to select from the classified state of the analyzed interaction record at least one classification from the group consisting of: satisfactory, unsatisfactory, and partially satisfactory.

13. The computer program product of claim 12, further comprising program code to actuate a second hardware device responsive to the unsatisfactory classification of the analyzed interaction record.

14. The computer program product of claim 13, further comprising program code to:
detect an anomalous interaction record read by the tone manager;
assign a label to the interaction record, the label selected from the group consisting of: biased and non-genuine;
detect a genuine interaction record, the interaction record having an assessment characteristic selected from the group consisting of: expected and unexpected; and
determine a source of the interaction record corresponding to the assessed characteristic.

15. A method for analyzing an interaction, comprising:
reading an interaction record and generating a tone graph based on the interaction record;
identifying and analyzing one or more characteristics within the generated tone graph;
classifying a state of the analyzed interaction record based on the analysis of the one or more characteristics identified by the analyzer within the generated tone graph;
transmitting an instruction output associated with the classified state of the analyzed interaction record to a first hardware device;
receiving, at the first hardware device, the instruction output associated with the classified state of the analyzed interaction record; and
the first hardware device performing a physical action selected from the group consisting of: changing a state of the first hardware device, actuating the first hardware device, and maintaining an operating state of the first hardware device.

16. The method of claim 15, further comprising:
leveraging a knowledge base including two or more data records, each record including at least one tone graph and at least one classification corresponding to the classified state of the analyzed interaction record; and
employing the data records to train a classification device.

17. The method of claim 15, further comprising determining a tone trend in real-time and generating a predicted outcome of the interaction record based on the tone trend.

18. The method of claim 17, further comprising selecting from the classified state of the analyzed interaction record at least one classification from the group consisting of: satisfactory, unsatisfactory, and partially satisfactory.

19. The method of claim 18, further comprising actuating a second hardware device responsive to the unsatisfactory classification of the analyzed interaction record.

20. The method of claim 19, further comprising:
detecting an anomalous interaction record read by the tone manager;
assigning a label to the interaction record, the label selected from the group consisting of: biased and non-genuine;
detecting a genuine interaction record, the interaction record having an assessed characteristic selected from the group consisting of: expected and unexpected; and
determining a source of the interaction record corresponding to the assessed characteristic.
